(19) United States
(12) Patent Application Publication
(10) Pub. No.: US 2009/0197087 A1
(43) Pub. Date: Aug. 6, 2009

(54) METHOD FOR PRODUCING A DECORATIVE SURFACE FOR AN ARTICLE AND AN ARTICLE DECORATED BY A SURFACE PRODUCED BY THE METHOD

(76) Inventor: Paul Waldvogel, Pratteln (CH)

Correspondence Address: EDWIN D. SCHINDLER, FIVE HIRSCH AVENUE, P.O. BOX 966, CORAM, NY, 11727-0966, US

(21) Appl. No.: 12/185,612

(22) Filed: Aug. 4, 2008

Related U.S. Application Data
(63) Continuation-in-part of application No. 29/321,963, filed on Jul. 26, 2008.

(30) Foreign Application Priority Data
Feb. 4, 2008 (CH) 134817

(51) Int. Cl. B32B 17/00; B32B 37/00

(52) U.S. Cl. 428/410; 156/60

(57) ABSTRACT

A method for producing an ornamental glass plate includes the steps of providing a shatterproof glass plate and affixing a supporting layer of material to one side of the shatterproof glass plate and, thereafter, exerting a blunt force to one surface of the shatterproof glass plate for splintering, or cracking, the glass plate. The shatterproof glass plate is preferably a laminated safety glass plate and the supporting layer of material is preferably a thin foil. The ornamental glass plate may be used to decorate various types of furniture and household articles.

### CROSS-REFERENCE TO PRIOR APPLICATION

This is a continuation-in-part of U.S. Design Patent Application Serial No. 29/321,963, filed Jul. 26, 2008, the entirety of the disclosure of which shall be deemed to be incorporated by reference herein.

### BACKGROUND OF THE INVENTION

The present invention relates, generally, to a method for producing a decorative surface for an article and an article decorated by a surface produced by the method.

More particularly, the present invention provides a method for creating a splintered laminated glass surface that can then be applied to various articles for decorating such articles, such as, for example, vases, cups or other household or furniture articles, etc., in an aesthetically pleasing and interesting manner.

### SUMMARY OF THE INVENTION

It is an object of the present invention to provide a method for producing a decorative surface for an article, such as common household and furniture articles, that is aesthetically pleasing and thereby enhances the general appearance and appeal of such articles.

It is a further object of the present invention to provide a decorative article having a surface layer that has been produced by the method of the present invention.

The foregoing and related objects are achieved by the present invention which provides a method for producing a glass plate for use, at least in part, as a decorative surface for an article that includes the steps of providing a laminated safety glass plate, preferably, though not necessarily, of rectangular shape, and gluing, or otherwise affixing, the laminated glass plate onto a thin foil surface, e.g., an aluminum foil surface, though other backing surfaces, such as a thin plastic film, are possible. The laminated glass plate, after affixation to a thin foil (or other appropriate) surface, is then preferably struck near one or its edges, preferably at, or near, a corner point of the plate glass, such as by a hammer, for causing the laminated glass plate to crack or splinter. Alternatively, the laminated glass plate may be struck in a central region thereof. Handcrafters, for example, may then use the splintered glass plate of the present invention by preferably providing a glue layer on the household or furniture article to be decorated, and then by laying the broken laminated safety glass plate with its thin foil or plastic film backing surface layer onto the layer of glue placed on the article, thereby proceeding to decorate the article.

The result of layering the broken laminated glass plate with its thin foil backing surface (or similar surface) onto the article to be decorated is that there will invariably be irregular distances between individual pieces of broken, or splintered, laminated glass of the broken plate. Once the glue having the splintered pieces of laminated glass and thin foil or film backing surface dries on the article to be decorated, a filler material, such as widely available putties, foams or plasters, well known to the skilled artisan, can be placed in the slits, or voids, between the pieces of splintered glass for completing the decorative surface of the article being decorated.

The terms “laminated glass plate” or “laminated safety glass plate,” and similar terminology, as used by the inventor in this Specification, are intended to cover any type of glass plate, whether or not designated as “safety” or “laminated,” that is otherwise deemed to be shatterproof, such that striking the glass plate with a blunt object, such as, for example, a hammer, will cause the glass plate to crack or splinter, but not to shatter. Such types of glass are commonly used, for example, in the manufacture of automobile windshields, though the glass plate used for purposes of the present invention would likely be thinner and of much smaller length and width than motor vehicle windshield glass.

The laminated glass plate of the present invention is preferably of rectangular shape and dimensioned 6 inches×8 inches, however, the precise size and shape of the laminated glass plate used will ultimately be dependent upon the object to be decorated.

It is a further option of the present invention to simply crack, or splinter, a laminated glass plate in accordance with the method of the present invention and to use the laminated cracked glass plate within its thin foil backing, or film backing, surface as an ornamental article in its own right, such as by displaying on a wall, perhaps with colored lighting directed toward the splintered laminated glass plate.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the accompanying drawing figures, wherein similar features are denoted by similar reference numerals throughout the several views:

FIG. 1 is an elevational view of a laminated glass plate, which has a thin foil backing surface, after being cracked, or splintered, in accordance with the method of the present invention;

FIG. 2 is an elevational view of a vase with the lower portion of the vase decorated with a layer of the laminated glass plate after being splintered, or cracked, in accordance with the present invention and with slits, or voids, between splintered pieces of the laminated glass plate being filled with a filler material and glued onto the vase; and,

FIG. 3 is a close-up elevational view of a mosaic created by the splintered laminated glass plate surfacing of the vase of FIG. 2.

### DETAILED DESCRIPTION OF THE DRAWING FIGURES AND PREFERRED EMBODIMENTS

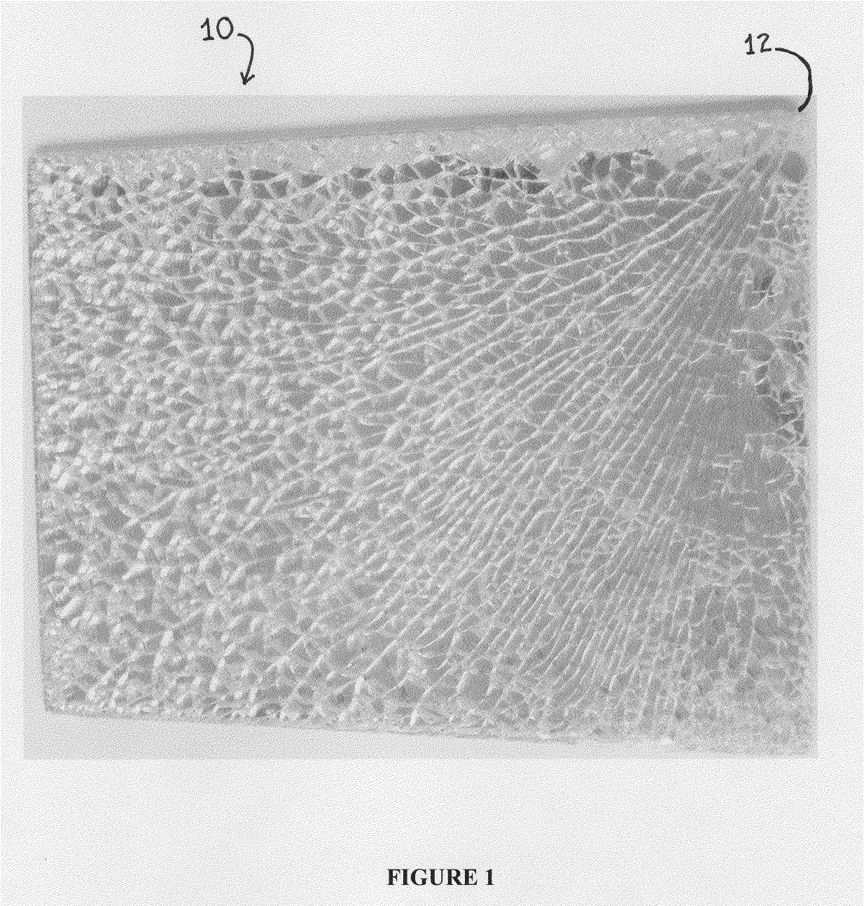

Turning now, in detail, to the accompanying drawing figures, FIG. 1 shows a rectangular piece of a laminated glass plate 10 that has been cracked, or splintered, in accordance with the method of the present invention. The cracked laminated glass plate was initially glued, or otherwise affixed, to a thin foil or film backing surface (not shown), such as an aluminum foil or plastic film backing surface, and then struck by a blunt object, such as a small hammer, near its upper-right hand corner 12, with cracks in the glass plate radiating from this corner of the splintered, or cracked, glass plate. This cracked glass plate 10 may be used as an ornamental display object in its own right or affixed to another article for decorating such other article.

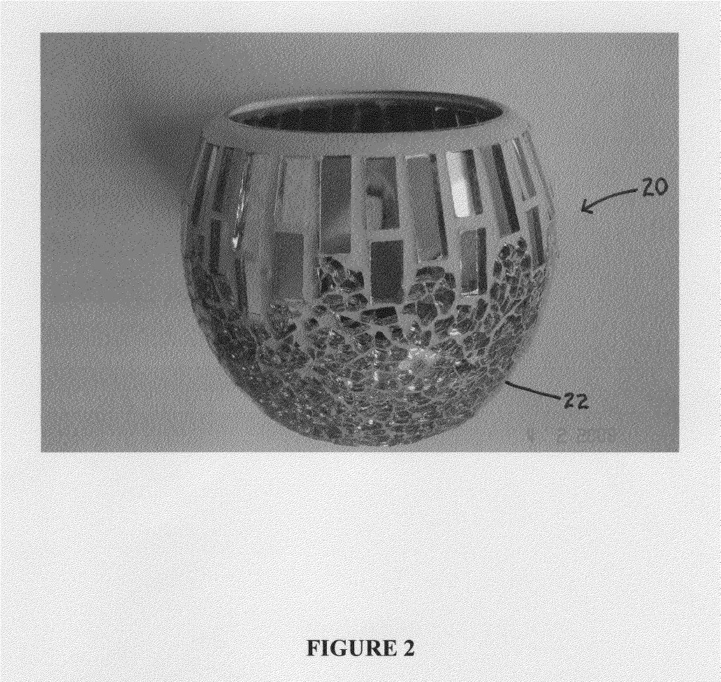

FIG. 2 is an elevational view of a vase 20 with the lower portion 22 of the vase decorated with a layer of the laminated glass plate 10 of FIG. 1 after being splintered or cracked in accordance with the present invention and with slits, or voids, between pieces of the laminated glass plate being filled with a filler material and glued onto vase 20. It is likely that the handicraft person decorating vase 20 will elect to first place a layer of glue on the portion of the article being decorated, and then apply the splintered laminated glass plate to the vase. It is likely to be useful to the handicraft person to use a small hammer or other object to gently nudge the individual splintered glass pieces of cracked glass plate 10 onto the article being decorated. The splintered, or cracked, laminated glass plate 10 might also have its own application of glue prior to securing to vase 20, or such other article to be decorated.

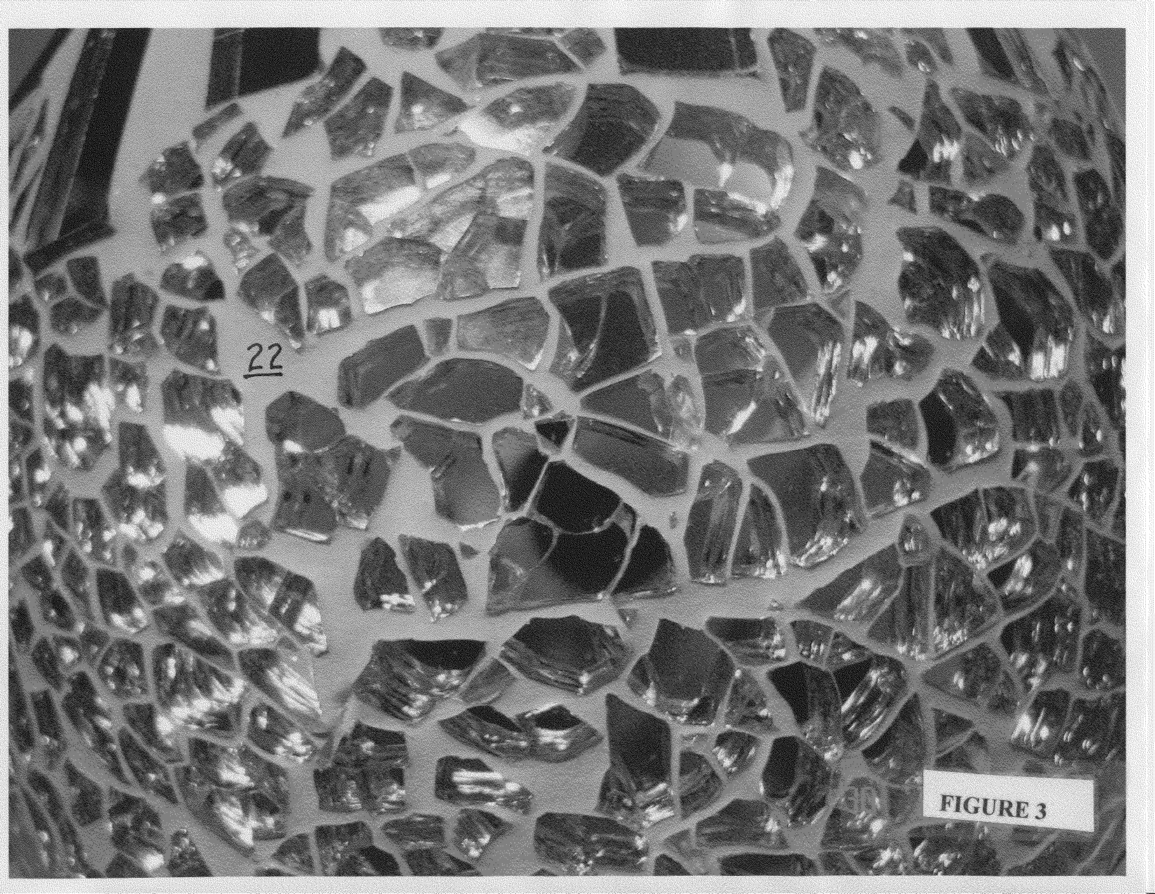

FIG. 3 is a close-up elevational view of a mosaic created by the laminated glass plate 10 of FIG. 1 following placement on the lower portion 22 of vase 20 of FIG. 2.

In an alternative, preferred embodiment of the present invention, the glass plate is a so-called “security glass plate,” which is being intentionally broken by hammering on one corner of the plate. The hammering causes splits to occur in the glass plate and, in this broken state, the glass plate is wrapped in a plastic foil while the broken glass plate lays on a cardboard. After putting glue onto the article to be decorated, a craftsman may—by hand—shift a piece of the broken plate comprising a multitude of splinters onto that gluey layer previously placed on the article. In this embodiment, the glass plate has no foil on it. Instead, the craftsman uses a small hammer and breaks the single splinters further, thereby creating what is shown in the lower portion 22 of the decorated vase 20. By splitting the splinters further, the splinters better follow the shape of the article to be decorated. Irregular seams are also created, which irregular seams are then filled in with a filler material and allowed to dry.

The article decorated in FIGS. 2 and 3 is a vase though, obviously, a broad range of objects may be appropriately and readily decorated with the cracked, or splintered, laminated glass plate of the present invention.

While only several embodiments of the present invention have been shown and described, it will be obvious to those skilled in the art that many modifications may be made to the present invention without departing from the spirit and scope thereof.

What is claimed is:

1. A method for producing an ornamental glass plate, comprising the steps of:
providing a shatterproof glass plate;
affixing a supporting layer of material to one side of the shatterproof glass plate; and,
exerting a blunt force to one surface of the shatterproof glass plate for splintering, or cracking, the shatterproof glass plate.

2. The method for producing an ornamental glass plate according to claim 1, wherein said shatterproof glass plate is a laminated glass plate.

3. The method for producing an ornamental glass plate according to claim 1, wherein said supporting layer of material affixed to said one side of the shatterproof glass plate is a foil material.

4. The method for producing an ornamental glass plate according to claim 3, wherein said foil material is an aluminum foil.

5. The method for producing an ornamental glass plate according to claim 1, wherein said supporting layer of material affixed to said one side of the shatterproof glass plate is a plastic film material.

6. The method for producing an ornamental glass plate according to claim 1, wherein said step of exerting a blunt force to one surface of the shatterproof glass plate includes the step of striking an edge of the shatterproof glass plate with a hammer.

7. The method for producing an ornamental glass plate according to claim 1, wherein said step of exerting a blunt force to one surface of the shatterproof glass plate includes the step of striking the shatterproof glass plate with the blunt force on the one surface not having said supporting layer of material.

8. The method for producing an ornamental glass plate according to claim 1, wherein the shatterproof glass plate is rectangular in shape and said step of exerting a blunt force to one surface of the shatterproof glass plate includes the step of striking a corner of the shatterproof glass plate with a hammer.

9. A method for producing an article having a decorative surface, comprising the steps of:
providing a shatterproof glass plate;
affixing a supporting layer of material to one side of the shatterproof glass plate;
exerting a blunt force to one surface of the shatterproof glass plate for splintering, or cracking, the shatterproof glass plate for producing a splintered glass plate;
affixing at least a portion of the splintered glass plate to at least a portion of a surface of an article to be decorated; and,
filling in voids between splintered pieces of the splintered glass plate with a filler material for producing an article having a decorative surface.

10. The method for producing an article having a decorative surface according to claim 9, wherein the shatterproof glass plate is a laminated glass plate.

11. The method for producing an article having a decorative surface according to claim 9, wherein the shatterproof glass plate is rectangular in shape and said step of exerting a blunt force to one surface of the shatterproof glass plate includes the step of striking a corner of the shatterproof glass plate with a hammer.

12. The ornamental glass plate produced according to the method of claim 1.
